(19) United States
(12) Patent Application Publication
(10) Pub. No.: US 2024/0382377 A1
(43) Pub. Date: Nov. 21, 2024

(54) COLD PLUNGE TUB

(71) Applicant: The Cold Life LLC, Alpharetta, GA (US)

(72) Inventors: Kyle Ponton, Alpharatta, GA (US); Samuel Maxwell, Duluth, GA (US); Alexander Hardy, Cumming, GA (US); Jerone Kollbaum, Buchanan, GA (US); Jennifer Lynn Schwert, Marietta, GA (US); Joshua Reed, Northlake, TX (US); Rafael Cerrada, Birmingham, AL (US); Samuel Geiger, Alpharetta, GA (US)

(21) Appl. No.: 18/667,719

(22) Filed: May 17, 2024

Related U.S. Application Data
(60) Provisional application No. 63/467,231, filed on May 17, 2023.

(51) Int. Cl. A61H 33/00

(52) U.S. Cl. CPC A61H 33/0095; A61H 33/6005; A61H 2033/0033; A61H 2033/0037; A61H 2201/0214; A61H 2201/0242

(57) ABSTRACT

A cold plunge tub includes an insulated tub basin sized to receive a portion of a person. The cold plunge tub comprises an outer tub sidewall and an inner tub sidewall. A ceramic insulative material can be placed between the outer tub sidewall and the inner tub sidewall and/or a seal formed, the inner tub sidewall defining a reservoir for receiving water therein, the reservoir sized to receive the portion of the person; and a tub lid removably covering and upper reservoir opening of the reservoir.

### REFERENCE TO RELATED APPLICATIONS

This application claims the benefit of U.S. Provisional Application No. 63/467,231, filed on May 17, 2023, which is hereby specifically incorporated by reference herein in its entirety.

### TECHNICAL FIELD

This disclosure relates to cold therapy devices. More specifically, this disclosure relates to a cold plunge tub.

### BACKGROUND

Cold therapy devices, such as ice packs, can be applied to the body used to reduce pain and inflammation and improve muscle recovery. Cold water therapy, including cold plunging and taking cold showers, can provide the same health benefits to an even larger area of the body, and can offer additional advantages including, but not limited to, enhancing mood and boosting metabolism. Cold plunging, which comprises submerging the body or portions thereof in cold water, is often performed in natural bodies of water, such as a lake or ocean, because controlled cold plunge facilities are not readily accessible.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a tub comprising: an insulated tub basin sized to receive a portion of a person and comprising: an inner tub sidewall defining a reservoir for receiving fluid therein and sized to receive the portion of the person; an outer tub sidewall surrounding the inner tub sidewall; and a seal formed between the outer tub sidewall and the inner tub sidewall; and a tub lid removably covering an upper reservoir opening of the reservoir.

Also disclosed is a tub comprising: an insulated tub basin sized to receive a portion of a person and comprising: an inner tub sidewall defining a reservoir for receiving fluid therein and sized to receive a portion of the person; an outer tub sidewall surrounding the inner tub sidewall; and ceramic insulation material between the outer tub sidewall and the inner tub sidewall; and a tub lid removably covering an upper reservoir opening of the reservoir.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a perspective view of a cold plunge tub, in accordance with one aspect of the present disclosure.

FIG. 2 is an exploded view of the cold plunge tub of FIG. 1.

FIG. 3 is another perspective view of the cold plunge tub of FIG. 1, wherein portions of the cold plunge tub are illustrated as transparent.

FIG. 4 is a detail view of a vacuum port of the cold plunge tub of FIG. 1.

FIG. 5 is an exploded view of a lower portion of the cold plunge tub of FIG. 1.

FIG. 6 is a bottom view of a tub lid for use with the cold plunge tub, in accordance with another aspect of the present disclosure.

FIG. 7 is a bottom perspective view of the tub lid of FIG. 6.

FIG. 8 is a front perspective view of a cooling unit for use with the cold plunge tub, in accordance with another aspect of the present disclosure.

FIG. 9 is a rear view of the cooling unit of FIG. 8.

FIG. 10 is a top view of the cold plunge tub of FIG. 1, illustrating example dimensions thereof.

FIG. 11 is a side view of the cold plunge tub of FIG. 1, illustrating example dimensions thereof.

FIG. 12 is an exploded view of the cold plunge tub in accordance with another aspect of the present disclosure.

FIG. 13 is a front view of the cold plunge tub of FIG. 12.

FIG. 14 is a cross-sectional view of the cold plunge tub of FIG. 12, taken along line B-B of FIG. 13.

FIG. 15 is a cross-sectional view of the cold plunge tub of FIG. 12, taken along line J-J of FIG. 13.

FIG. 16 is a detail view of the cold plunge tub of FIG. 12, taken from Detail K of FIG. 15.

FIG. 17 is a cross-sectional view of the cold plunge tub of FIG. 12, taken along line C-C of FIG. 13.

FIG. 18 is a top view of the cold plunge tub of FIG. 12.

FIG. 19 illustrates the tub lid in accordance with another example aspect of the disclosure.

FIG. 20 illustrates the tub lid in accordance with another example aspect of the disclosure.

FIG. 21 illustrates the tub lid in accordance with another example aspect of the disclosure.

FIG. 22 illustrates the tub lid in accordance with another example aspect of the disclosure.

FIG. 23A is a front perspective view of a cold plunge tub with a cooling unit, in accordance with another aspect of the present disclosure.

FIG. 23B is a detailed perspective view of the cooling unit in FIG. 23A taken from Detail B in FIG. 23A.

FIG. 24 is a perspective view of the cold plunge tub of FIG. 23A.

FIG. 25 is a perspective view of the cold plunge tub with portions of the cold plunge tub shown in transparent.

FIG. 26 is a top view of the cold plunge tub of FIG. 23A.

FIG. 27 is an exploded view of the cold plunge tub of FIG. 23A.

FIG. 28 a perspective view of the tub bottom wall coupled to an adapter.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a cold plunge tub and associated methods, systems, devices, and various apparatus. Example aspects of the cold plunge tub can comprise an insulating tub basin defining a reservoir for housing cold water. It would be understood by one of skill in the art that the cold plunge tub is described in but a few exemplary embodiments among many. No particular terminology or description should be considered limiting on the disclosure or the scope of any claims issuing therefrom.

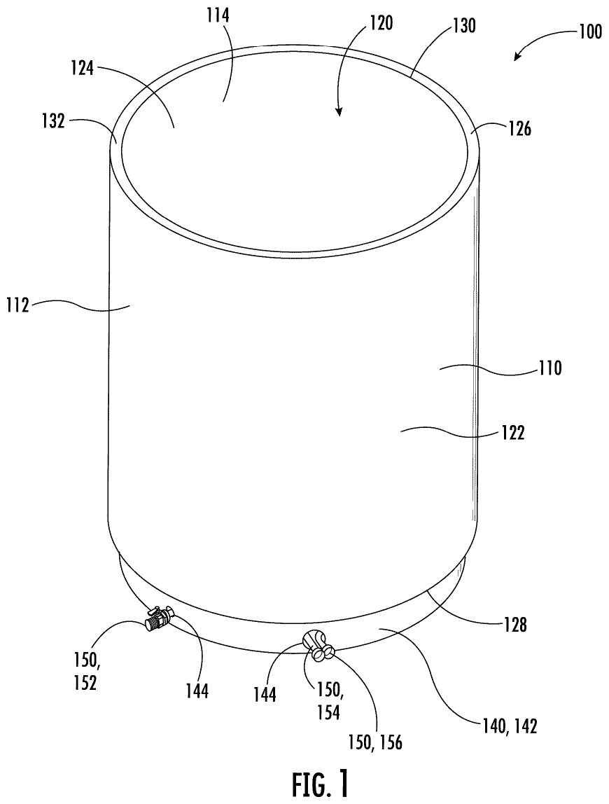

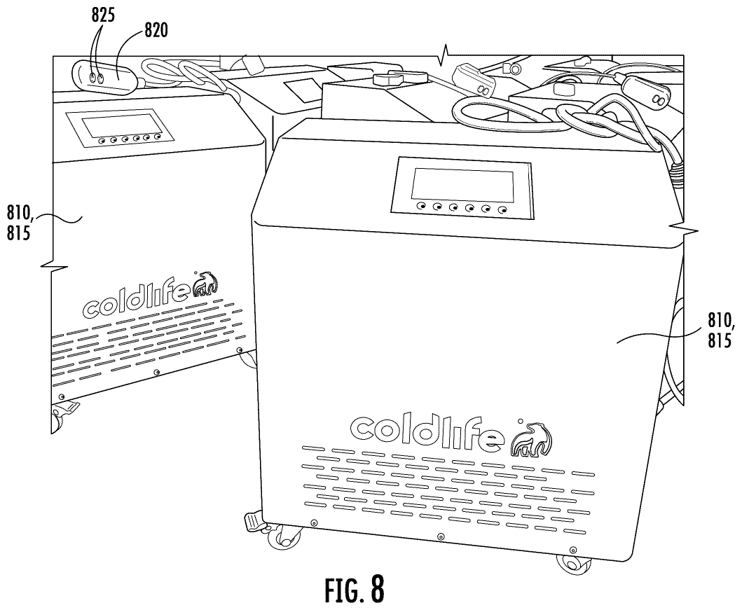

FIG. 1 is a perspective view of a cold plunge tub 100, in accordance with one aspect of the present disclosure. According to example aspects, the cold plunge tub 100 can comprise an insulating tub basin 110. The insulating tub basin 110 can define an outer tub surface 112 and an inner tub surface 114. The inner tub surface 114 can define a reservoir 120 for receiving water or fluid therein, and the reservoir 120 can be sized to receive a person. The water received in the reservoir 120 can be cooled by an internal or external chiller, cooler, or cooling unit 810 (shown in FIG. 8), as described in further detail below. A user can access the reservoir 120 to submerge or partially submerge themselves in the cooled water. Submerging oneself in cooled water can provide a variety of health benefits, including but not limited to reducing pain and inflammation, improving circulation and muscle recovery, enhancing mood and mental health, and boosting metabolism. In some aspects, the cooling unit 810 can be a cooling/heating unit 815 (shown in FIG. 8) that can also heat the water in the reservoir 120 as desired. For example cooling/heating unit 815 can comprise a heater and a chiller/cooler. Submerging oneself in heated water can provide a variety of health benefits, including but not limited to increased muscle relaxation, the flushing of toxins from the skin, and improved sleep quality. Such cooling units 810 and cooling/heating units 815 for cooling and/or heating water are known in the art. In some aspects, the cold plunge tub 100 may not comprise the cooling unit 810, and the water in the reservoir 120 can be cooled by placing ice, ice packs, or other cold packs in the reservoir 120.

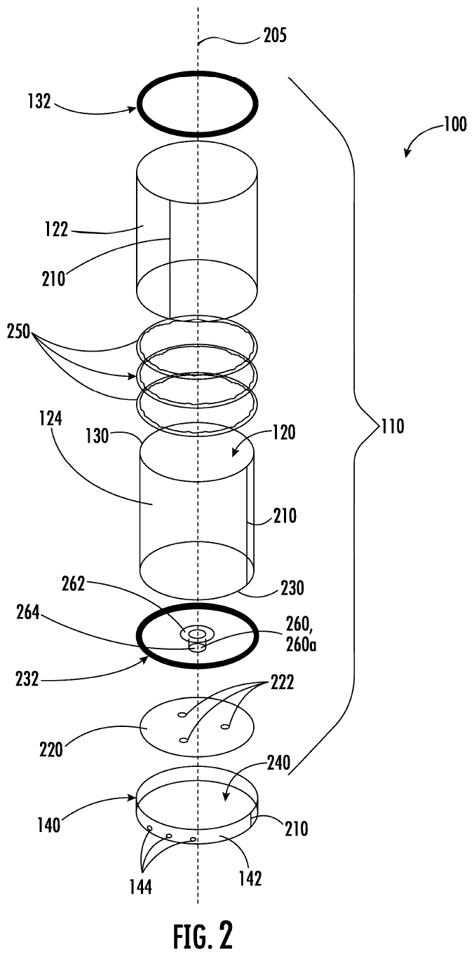

In the present aspect, the insulating tub basin 110 can be substantially cylindrical in shape, and the reservoir 120 can define a substantially circular cross-sectional shape. However, in other aspects, the insulating tub basin 110 can define any other suitable shape known in the art and/or the reservoir 120 can define any other suitable cross-sectional shape known in the art. For example and without limitation, in other aspects, the insulating tub basin 110 can define the shape of an elliptical cylinder or a square or rectangular prism, and the reservoir 120 can define an oval, square, or rectangular cross-sectional shape. According to example aspects, the insulating tub basin 110 can define an outer tub sidewall 122 and an inner tub sidewall 124 disposed radially inward of the outer tub sidewall 122. The outer tub sidewall 122 can at least partially define the outer tub surface 112 of the insulating tub basin 110, and the inner tub sidewall 124 can at least partially define the inner tub surface 114 of the insulating tub basin 110. The inner tub sidewall 124 can thereby at least partially define the reservoir 120. The insulating tub basin 110 can further define an upper tub end 126 and a lower tub end 128 opposite the upper tub end 126. The inner tub sidewall 124 can define an upper reservoir opening 130 at the upper tub end 126 to allow access to the reservoir 120 of the cold plunge tub 100. The insulating tub basin 110 can be substantially closed at the lower tub end 128 by a tub bottom wall 220 (shown in FIG. 2) to retain the water within the reservoir 120. The tub bottom wall 220 can at least partially define the inner tub surface 114 and can thereby further define the reservoir 120.

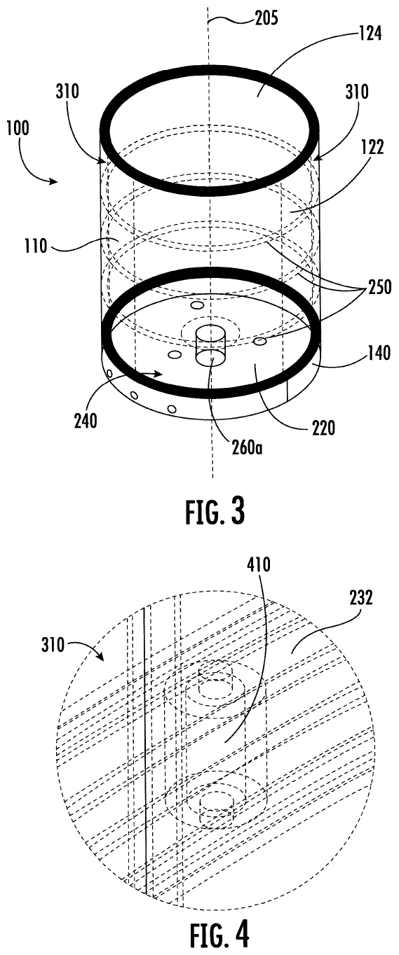

An annular gap 310 (shown in FIG. 3) can be defined between the outer tub sidewall 122 and the inner tub sidewall 124, and in some aspects, the annular gap 310 can be vacuum-sealed to enhance the insulation provided by the insulating tub basin 110, as described in further detail below. The annular gap 310 can thermally isolate a temperature of the inner tub sidewall 124 from the outer tub sidewall 122. According to example aspects, the insulating tub basin 110 can comprise an upper sealing ring 132 configured to seal the annular gap 310 between the outer and inner tub sidewalls 122,124 at the upper tub end 126 and a lower sealing ring 232 (shown in FIG. 2) configured to seal the annular gap 310 at the lower tub end 128 to maintain the vacuum seal between the outer and inner tub sidewalls 122,124. In other aspects, the annular gap 310 may not be vacuum-sealed. In other aspects, the insulating tub basin 110 can define more or fewer sidewalls. For example, in some aspects, the insulating tub basin 110 can define a singular sidewall that can at least partially define both the outer tub surface 112 and the inner tub surface 114.

Example aspects of the insulating tub basin 110 can be supported above a support surface (e.g., a ground or floor surface) by a tub base 140. The tub base 140 can comprise a substantially cylindrical base wall 142 in the present aspect, and the lower sealing ring 232 and/or the base bottom wall of the insulating tub basin 110 can rest on the tub base 140. In other aspects, the base wall 142 can define any suitable shape. The base wall 142 can define a substantially hollow interior base cavity 240 (shown in FIG. 2) beneath the tub bottom wall 220, which can be configured to house various internal components of the cold plunge tub 100, such as various plumbing components 150. As shown, in some aspects, the base wall 142 can define one or more base plumbing openings 144 through some or all of the plumbing components 150 can extend. The plumbing components 150 can include, for example and without limitation, a drain hose 152 for draining water from the reservoir 120, an inlet hose 154 for pumping water from the cooling unit 810 into the reservoir 120, and an outlet hose 156 for circulating the water in the reservoir 120 back to the cooling unit 810.

FIG. 2 illustrates an exploded view of the cold plunge tub 100. As shown, the cold plunge tub 100 can comprise the insulating tub basin 110 and the tub base 140 configured to support the insulating tub basin 110 above a support surface. The insulating tub basin 110 can comprise the outer tub sidewall 122 and the inner tub sidewall 124. In example aspects, each of the outer tub sidewall 122 and the inner tub sidewall 124 can comprise a metal material, such as stainless steel or carbon steel, for example and without limitation. In some aspects, each of the outer tub sidewall 122 and the inner tub sidewall 124 can be formed from a piece of sheet metal that can be rolled to define the cylindrical shape shown. Each of the outer tub sidewall 122 and the inner tub sidewall 124 can be welded at a substantially vertical seam 210, as shown, to hold the sheet metal in the rolled configuration. In other aspects, any other suitable fastener or fastening technique can be utilized to retain the sheet metal in the rolled configuration. In other aspects, the outer and/or inner tub sidewalls 122,124 can comprise any other suitable material and/or can be formed by any other suitable manufacturing technique.

The inner tub sidewall 124 can define the upper reservoir opening 130 at the upper tub end 126 (shown in FIG. 1) of the insulating tub basin 110 and a lower reservoir opening 230 at the lower tub end 128 (shown in FIG. 1) of the insulating tub basin 110. The tub bottom wall 220 can be disposed at the lower tub end 128 and can cover the lower reservoir opening 230. The inner tub sidewall 124 and the tub bottom wall 220 can thereby define the reservoir 120. Example aspects of the tub bottom wall 220 can define one or more tub plumbing openings 222 configured to receive and/or provide access to the plumbing components 150 housed within the substantially hollow interior base cavity 240 of the tub base 140, as described in further detail below.

According to example aspects, the annular gap 310 (shown in FIG. 3) defined between the outer tub sidewall 122 and the inner tub sidewall 124 can be vacuum-sealed. The insulating tub basin 110 can comprise the upper sealing ring 132 configured to seal the annular gap 310 between the outer and inner tub sidewalls 122,124 at the upper tub end 126 and the lower scaling ring 232 configured to seal the annular gap 310 at the lower tub end 128. The upper and lower scaling rings 132,232 can comprise a metal material, such as carbon steel, in some aspects. In other aspects, the upper and lower sealing rings 132,232 can comprise any other suitable material. Additionally, in some aspects, one or more reinforcement rings 250 can be disposed within the annular gap 310 between the outer tub sidewall 122 and the inner tub sidewall 124. For example, in the present aspect, three of the reinforcement rings 250 can be spaced apart longitudinally within the annular gap 310 to provide added structural support to the outer and inner tub sidewalls 122,124. Other aspects of the cold plunge tub 100 can comprise more or fewer reinforcement rings 250, while other aspects of the cold plunge tub 100 may not comprise any of the reinforcement rings 250.

As shown, the tub base 140 can comprise the substantially cylindrical base wall 142. In some aspects, similar to the outer and inner tub sidewalls 122,124, the base wall 142 can comprise a metal material, such as such as stainless steel or carbon steel, and can be formed by rolling a piece of sheet metal to define the cylindrical shape. In other aspects, the base wall 142 can comprise any other suitable material and/or can be formed by any other suitable manufacturing technique. The base wall 142 can encircle the substantially hollow interior base cavity 240, and the interior base cavity 240 can house the various internal plumbing components 150 (shown in FIG. 1). As shown, the base wall 142 can define the base plumbing openings 144 and the tub bottom wall 220 can define the tub plumbing openings 222. The internal plumbing components 150 can be in fluid communication with the reservoir 120 through the tub plumbing openings 222, and the internal plumbing components 150 can extend through the base plumbing openings 144 to the external environment surrounding the cold plunge tub 100.

The base wall 142 can provide annular support the insulating tub basin 110 at the lower tub end 128. In example aspects, an outer diameter of the base wall 142 can be about equal to or slightly less than an outer diameter of the insulating tub basin 110 to provide stable support to the insulating tub basin 110 proximate to an outer circumference thereof. In some aspects, the cold plunge tub 100 can further comprise one or more tub supports 260 extending downward from the tub bottom wall 220 and through the interior base cavity 240 to engage the support surface on which the tub base 140 sits. In the present aspects, the cold plunge tub 100 can comprise one of the tub supports 260, which can be a central tub support 260a extending downward from a center of the tub bottom wall 220 and providing support to the insulating tub basin 110 along a central basin axis 205 thereof. The central tub support 260a can comprise a substantially circular support plate 262 coupled to the tub bottom wall 220 and a substantially cylindrical support post 264 extending from the support plate 262 and configured to engage the support surface. In other aspects, the support post 264 can be directly affixed to the tub bottom wall 220.

FIG. 3 illustrates a perspective view of the cold plunge tub 100, wherein the outer tub sidewall 122 and the inner tub sidewall 124 are illustrated as translucent for visibility of the reinforcement rings 250 received in the vacuum-sealing annular gap 310 therebetween. Additionally, the tub bottom wall 220 is illustrated as translucent for visibility of the central tub support 260a disposed within the interior base cavity 240 of the tub base 140 and providing support to the tub bottom wall 220 along the central basin axis 205 of the insulating tub basin 110.

FIG. 4 illustrates a vacuum port 410 formed through the lower sealing ring 232 of the insulating tub basin 110 (shown in FIG. 1). The vacuum port 410 can be in communication with the annular gap 310 formed between the outer tub sidewall 122 (shown in FIG. 1) and the inner tub sidewall 124 (FIG. 1) and can allow the air received within the annular gap 310 to be suctioned out of the annular gap 310 to form the vacuum seal. The vacuum-scaling of the annular gap 310 can improve the insulation capability of the insulating tub basin 110 to help maintain the temperature of the cooled or heated water received in reservoir 120 (shown in FIG. 1) both during and between uses. For example, an operator can set a predetermined temperature (e.g., a user-set temperature), and the system will maintain the fluid at that temperature so that tub 100 is ready when the user returns to the system. In other aspects, the vacuum port 410 can be formed through the upper sealing ring 132 (shown in FIG. 1), the outer tub sidewall 122, or at any other suitable location where the vacuum port 410 can be in communication with the annular gap 310.

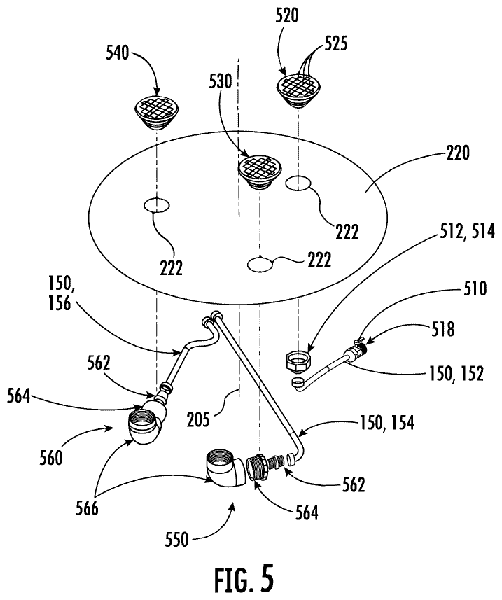

FIG. 5 illustrates the tub bottom wall 220 of the insulating tub basin 110 (shown in FIG. 1) and the various plumbing components 150. The plumbing components 150 can include the drain hose 152 for draining water from the reservoir 120 to the external environment surrounding the cold plunge tub 100 (shown in FIG. 1). For example, the water can be drained onto the support surface (such as the ground) on which the cold plunge tub 100 is supported. The drain hose 152 can be in fluid communication with the reservoir 120 and can be selectively opened and closed by a drain valve 510. In example aspects, the drain hose 152 can be coupled to the tub bottom wall 220 by a drain fastener 512, which in the present aspect can be a first garden hose adapter 514. In other aspects, the drain fastener 512 can be any other suitable fastener known in the art. According to example aspects, a drain filter 520 can engage a corresponding one of the tub plumbing openings 222, and the drain fastener 512 can be coupled to the drain filter 520. The drain filter 520 can comprise a plurality of filter holes 525 therethrough which can allow water to flow therethrough from the reservoir 120 into the drain hose 152. The drain filter 520 can further prevent larger particles and/or objects from passing therethrough, and the larger particles and/or objects can then easily be removed or cleaned from the reservoir 120.

In some aspects, a second garden hose adapter (not shown) can be removably or permanently coupled to an outlet end 518 of the drain hose 152 to allow a garden hose to be attached thereto. The reservoir 120 can thereby be drained through a garden hose to a location that is distanced away from the cold plunge tub 100. For example, if the cold plunge tub 100 is housed inside (e.g., inside of a sports or therapy facility or a user's home), the garden hose can be coupled to the drain hose 152 by the second garden hose adapter and can be fed outside through a door or window to drain the water outside.

The plumbing components 150 can also comprise the inlet hose 154 for pumping water from the cooling unit 810 into the reservoir 120 and the outlet hose 156 for circulating the water back from the reservoir 120 to the cooling unit 810. Similar to the drain hose 152, each of the inlet hose 154 and the outlet hose 156 can be in fluid communication with the reservoir 120 and can be coupled to the tub bottom wall 220. More specifically, the inlet hose 154 can be connected to an inlet filter 530 engaged with a second one of the tub plumbing openings 222, and the outlet hose 156 can be connected to an outlet filter 540 engaged with a third one of the tub plumbing openings 222. Like the drain filter 520, each of the inlet filter 530 and the outlet filter 540 can comprise a plurality of the filter holes 525 configured to allow water flow therethrough and to strain out larger particles and/or objects in the water.

An inlet fastener 550 can connect the inlet hose 154 to the inlet filter 530 and an outlet fastener 560 can connect the outlet hose 156 to the outlet filter 540. In the present aspect, each of the inlet fastener 550 and the outlet fastener 560 can comprise a garden hose fitting 562 connected to the corresponding inlet hose 154 or outlet hose 156, a pipe fitting 564 connected to the garden hose fitting 562, and an elbow fitting 566 connected to the pipe fitting 564. The elbow fitting 566 can be coupled to the corresponding inlet filter 530 or outlet filter 540. In example aspects, the pipe fittings 564 and elbow fittings 566 can comprise a PVC (polyvinyl chloride) material. In other aspects, the pipe fittings 564 and/or elbow fittings 566 can comprise any other suitable material. In other aspects, the inlet fastener 550 and/or outlet fastener 560 can be any other suitable fastener known in the art.

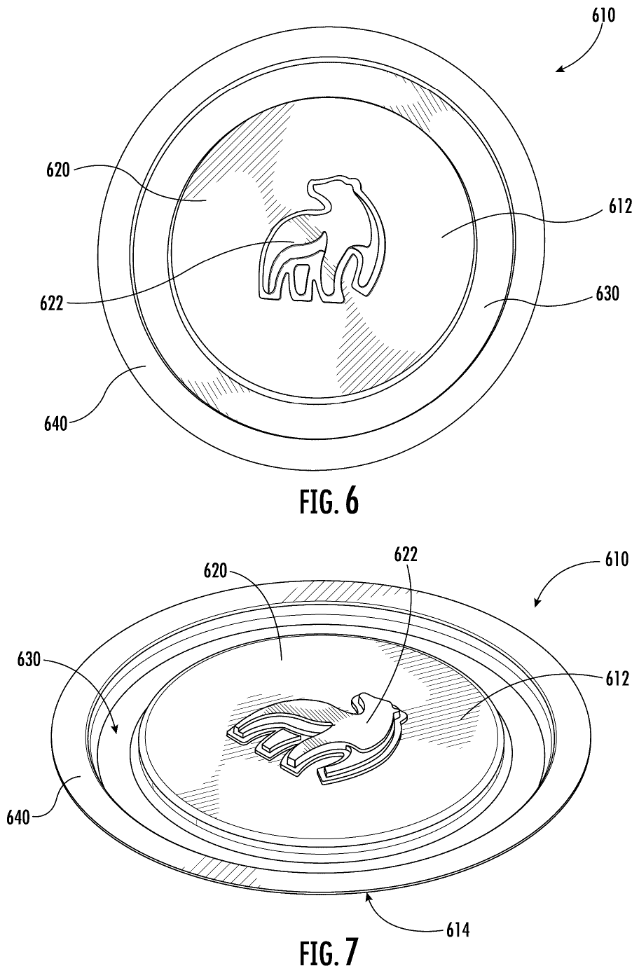

Referring now to FIGS. 6 and 7, the cold plunge tub 100 (shown in FIG. 1) can be provided with a tub lid 610 in some aspects. The tub lid 610 can removably cover the upper reservoir opening 130 while the cold plunge tub 100 is not in use to protect the reservoir 120 from debris (e.g., dirt, dust, etc.) and to further insulate the reservoir 120 and the water therein. The tub lid 610 can thereby aid in maintaining the temperature of the cooled or heated water between uses. Example aspects of the tub lid 610 can comprise a plastic material that can be thermoformed into a desired shape, such as the shape illustrated herein. In other aspects, however, the tub lid 610 can comprise any other suitable material and/or shape, and/or the tub lid 610 can be formed by any suitable manufacturing process.

The tub lid 610 can define an inner lid surface 612 configured to face the reservoir 120 and an outer lid surface 614 (shown in FIG. 7) configured to face away from the reservoir 120. Example aspects of the tub lid 610 can comprise a central cover portion 620 configured to cover the upper reservoir opening 130. The central cover portion 620 can be substantially planar and circular in the present aspect. In some aspects, as shown, a logo 622 or other indicia can be formed in or otherwise applied to the central cover portion 620. An annular lid groove 630 can be formed in the inner lid surface 612 of the tub lid 610 and can be configured to receive the upper tub end 126 (shown in FIG. 1) of the insulating tub basin 110 (shown in FIG. 1) to prevent lateral movement of the tub lid 610 relative to the insulating tub basin 110. Additionally, in some aspects, the tub lid 610 can define an annular lid rim 640 extending radially outward from the annular lid groove 630. The annular lid rim 640 can provide a gripping region to facilitate placing the tub lid 610 onto or removing the tub lid 610 from the insulating tub basin 110.

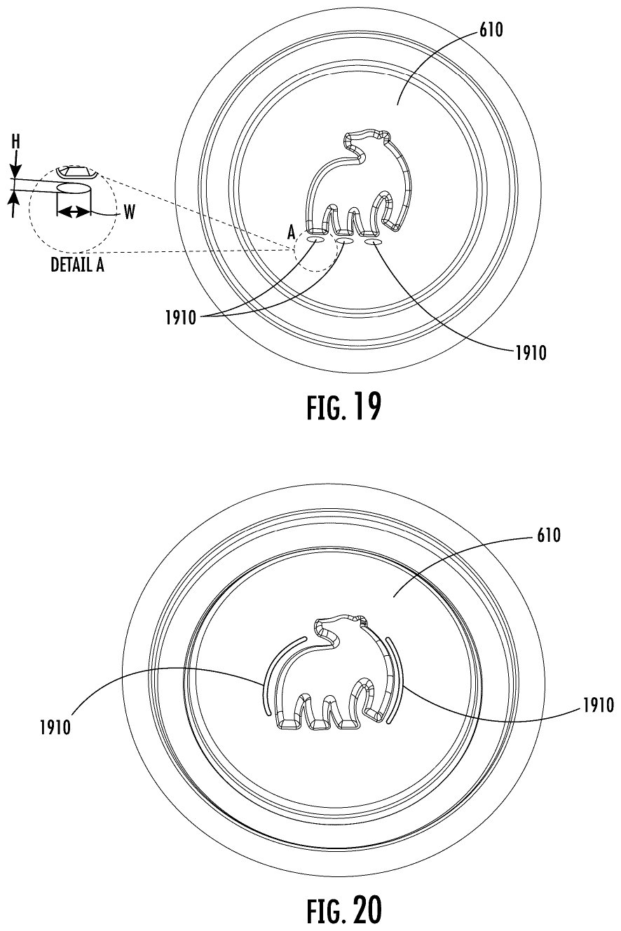

In some aspects, one or more lid vents 1910 (shown in FIG. 19), such as vent slots or vent holes, can be formed through the tub lid 610, and more specifically, through the central cover portion 620 covering the reservoir 120. The lid vents 1910 can allow air in the reservoir 120 and/or steam from heated water to escape through the tub lid 610. In example aspects, the water in the reservoir 120 can comprise chemicals, such as sanitizing chemicals, which can accumulate in the reservoir 120 if not properly vented. It can thus be desirable to prevent a buildup of the chemicals by allowing the air in the reservoir 120 to be vented through the tub lid 610.

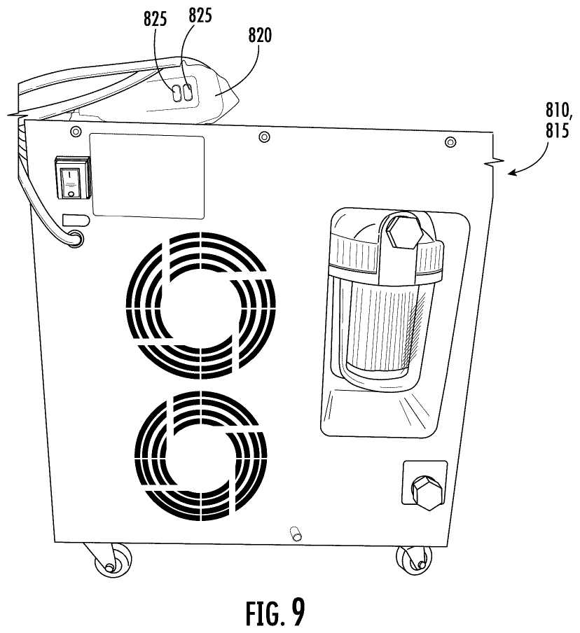

FIGS. 8 and 9 illustrate the cooling unit 810, which can be the cooling/heating unit 815 in the present aspect. The cooling unit 810 can be disposed external to the cold plunge tub 100 (shown in FIG. 1); however, in other aspects, the cooling unit 810 can be internal. For example, the cooling unit 810 may be housing within the interior base cavity 240 (shown in FIG. 2). According to example aspects, the cooling/heating unit 815 can be connected to a tap or other water source and can cool or heat the water received from the water source. The cooling/heating unit 815 can then circulate the cooled or heated water into and out of the reservoir 120 (shown in FIG. 1) via the inlet and outlet hoses 154,156 (shown in FIG. 1), respectively. In some aspects, the cooling unit 810 can be operated (e.g., turned on/off, temperature selected, etc.) by a handheld control device 820 comprising one or more buttons 825, as shown. In some aspects, the cooling unit 810 could be a Model No. SY-06-HC/OC manufactured and sold by Shenzhen Syochi Electronics Co., LTD., although other cooling units 810 can be used in other aspects. In addition to cooling and heating the water, example aspects of the cooling/heating unit 815 can further be configured to sanitize the water as it circulates therethrough (for example, with the sanitizing chemicals mentioned previously), thereby allowing the water in the cold plunge tub 100 to remain clean both during and between uses. In some aspects, the cold plunge tub 100 may not be provided with the cooling/heating unit 815, and the water in the reservoir 120 can be cooled with ice, ice packs, or other cold packs.

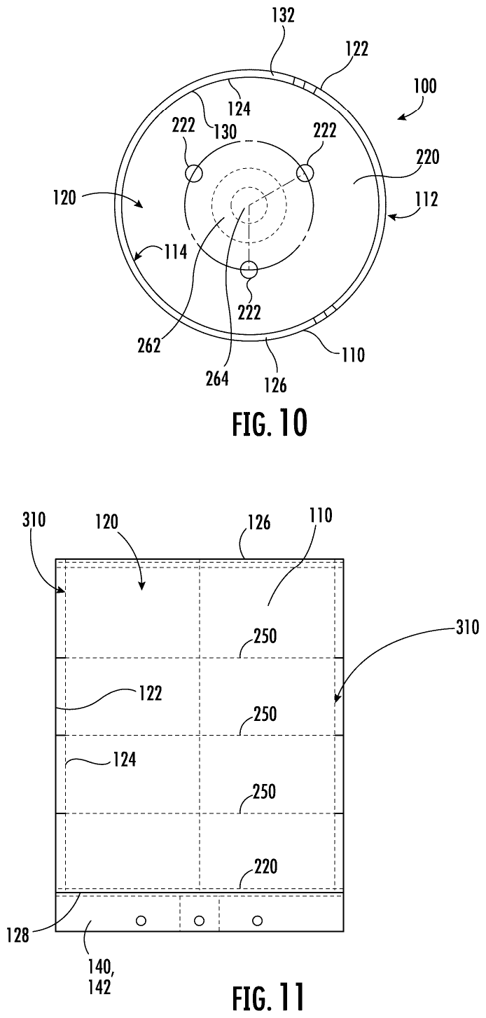

FIGS. 10 and 11 illustrate top and side views, respectively, of the cold plunge tub 100 of FIG. 1-5. Various example dimensions of the cold plunge tub 100 are shown in FIGS. 10 and 11; however, the dimensions are merely exemplary and should not be construed as limiting.

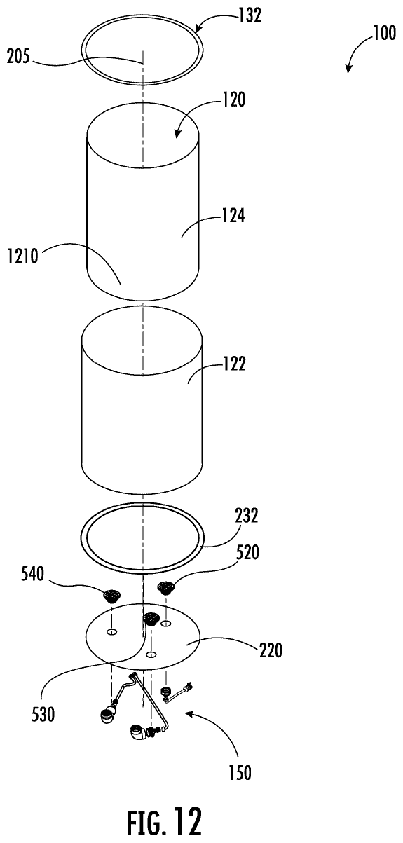

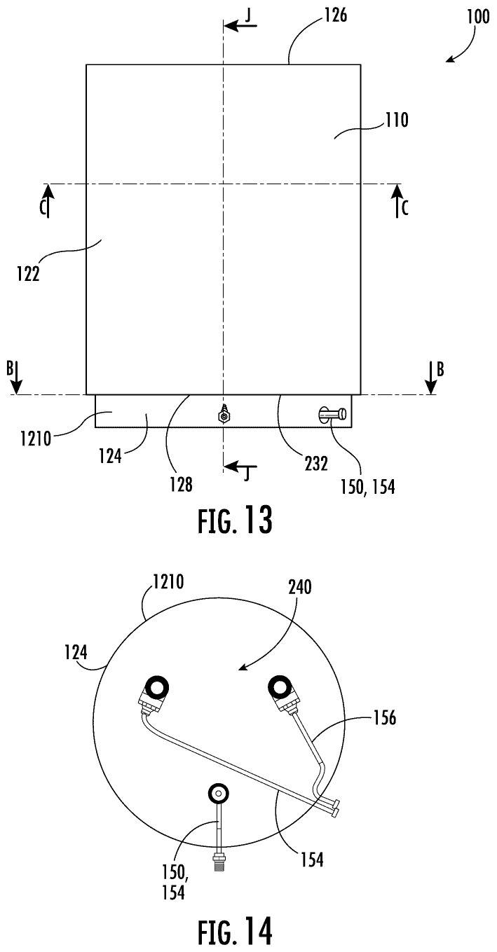

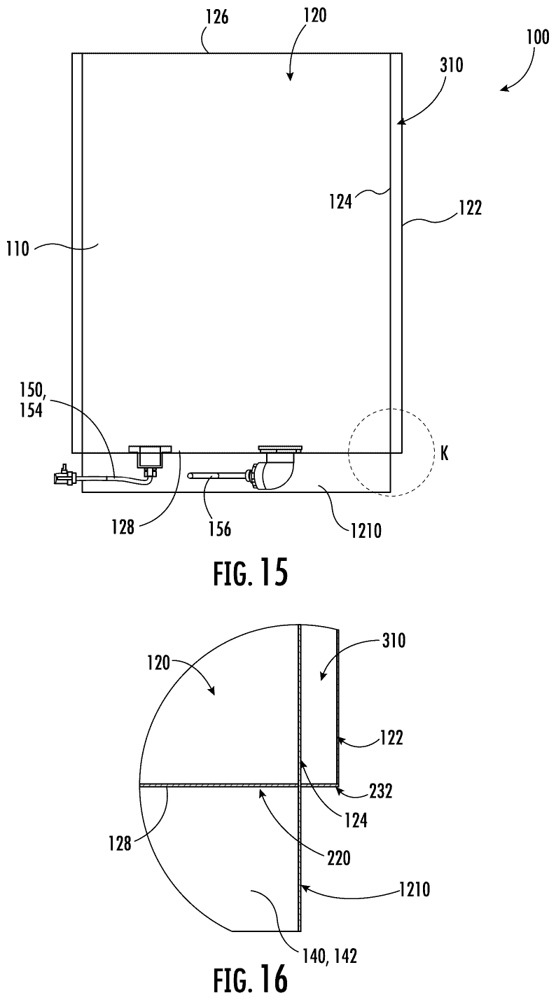

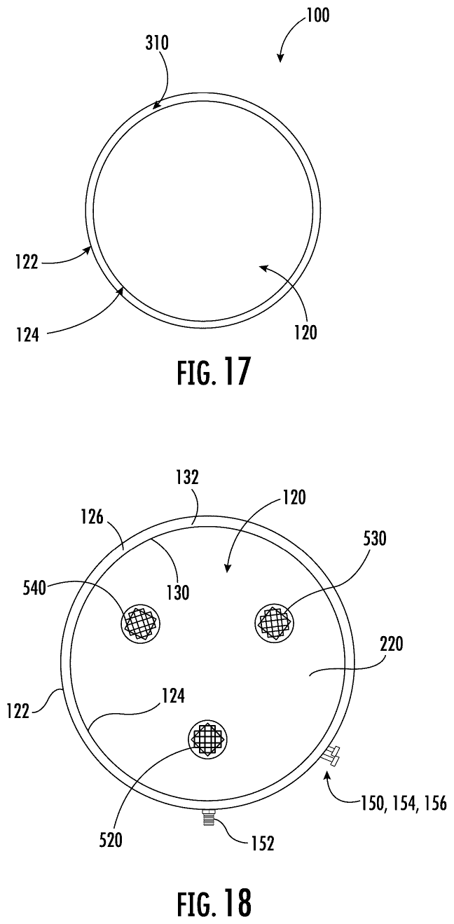

FIG. 12 illustrates an exploded view of the cold plunge tub 100, according to another example aspect of the present disclosure. FIGS. 13-18 illustrate additional view of the cold plunge tub 100 of FIG. 12. As best shown in FIG. 16, in the present aspect, a lower wall portion 1210 of the inner tub sidewall 124 can extend downward beyond the lower tub end 128 of the insulating tub basin 110 (i.e., past the lower sealing ring 232) to define the base wall 142 of the tub base 140. FIG. 17 discloses various dimensions of the cold plunge tub 100, which are merely exemplary and should not be construed as limiting.

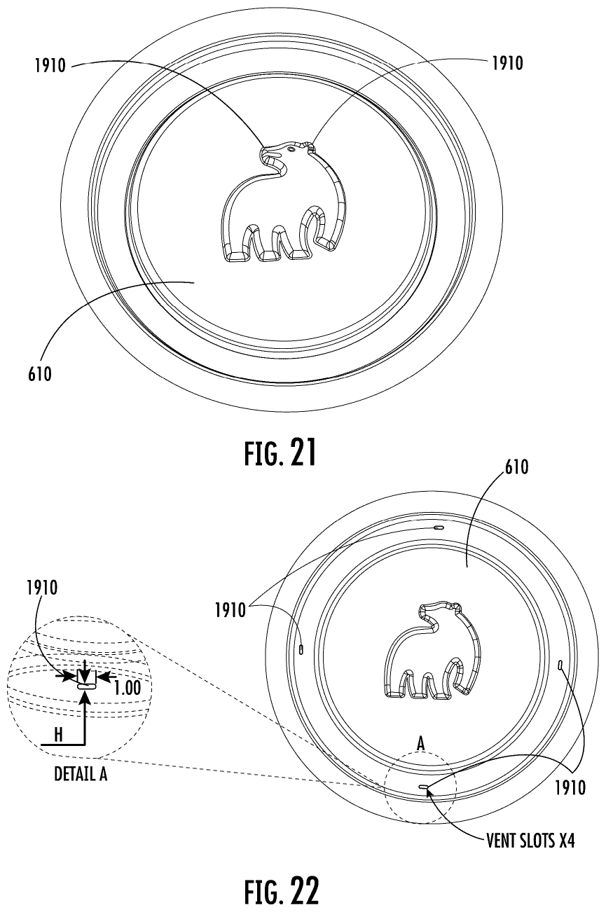

FIGS. 19-22 illustrate additional example aspects of the tub lid 610 comprising the lid vents 1910. As shown, the lid vents 1910 formed through the tub lid 610 can define any suitable size and shape, and can be formed at any suitable location, including, for example, at the central cover portion 620 and/or at the annular lid groove 630. The lid vents 1910 can be configured to allow steam and/or air within the reservoir 120 (shown in FIG. 1) to escape to the external environment.

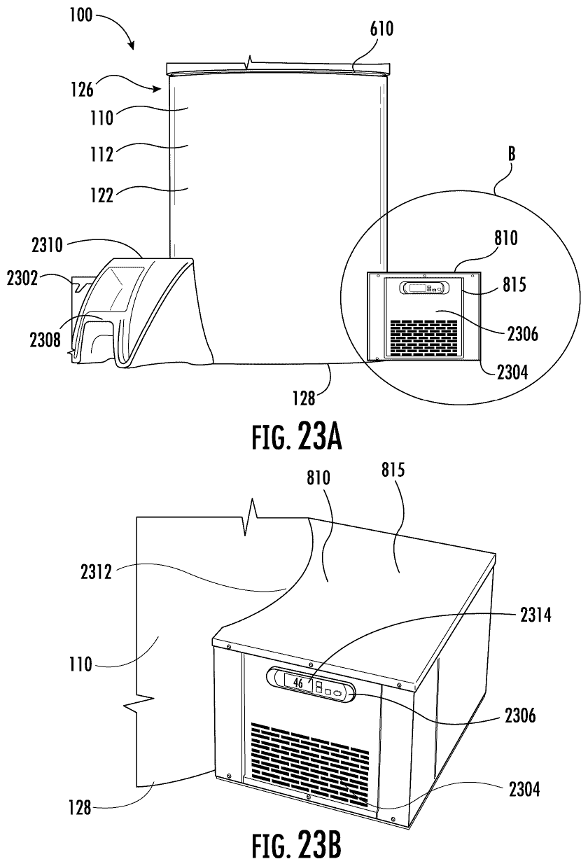

FIG. 23A is a front perspective view of a cold plunge tub 100 with a cooling unit 810. The cooling unit 810 comprises a power unit that cools the water temperature down to near 0° C. (32° F.). For example, cooling unit 810 can reduce the water temperature to at or below 3° C. (37° F.) for extended periods. In some aspects, cooling unit 810 maintains a constant water temperature of 3° C. (37° F.) or below for 24 or 48 hours. In some aspects, the cooling unit 810 can comprise a heating unit 815 or can be a joint heating/cooling unit 815.

As illustrated, an ergonomic device 2302 can be joined to the outer tub surface 112 and/or outer tub sidewall 122. The vertical design of the cold plunge tub 100, ergonomic device 2302, and/or cooling unit 810 can reduce the footprint of the cold plunge tub 100. In some aspects, the cooling unit 810 can be implemented in, around, or within the insulating tub basin 110 and/or the ergonomic device 2302. For example, the cooling unit 810 can be placed under or within the ergonomic device 2302. An internal filter 2304 and/or a pump 2306 can be implemented in the cooling unit 810 to cycle the water and eliminate debris to keep the water clean between uses and reduce maintenance of the system. In various aspects, the filter 2304 can comprise a two-step filtration system, for example, filter 2304 can be a dual filtration filter that filters the water in stages before being cycled through the pump 2306. Also shown at 2306 in FIG. 23A is venting on an exterior of the cooling unit 810 that can allow for excess heat from the cooling unit 810 that may be created during cooling and/or heating to escape from the cooling unit 810. In some aspects, the cooling unit 810 can comprise a display and control panel that can be used to control the cooling unit 810 and thereby regulate the temperature of the fluid within the tub basin 110. In some aspects, the ergonomic device 2302 can double as a stool or step 2308 to gain entry into the cold plunge tub 100 and as a seat 2310, e.g., by placing the ergonomic device 2302 within reservoir 120 and/or on the inner tub sidewall 122.

FIG. 23B is a detailed view of the cooling unit 810. As used herein, cooling unit 810 similarly describes heating unit 815, but cooling unit 810 is used for convenience. That is, cooling unit 810 refers to one or more of cooling unit 810, heating unit 815, and/or a cooling and heating unit 810, 815.

FIG. 23B shows the cooling unit 810 configured with a radius or curvature 2312 that is approximately equal to a radius of curvature of the insulating tub basin 110. The curvature 2312 facilitates a close connection between the tub 100 and the cooling unit 810. This close connection can be facilitated by the positioning of the locations of the drain hose 152, the inlet hose 154, and the outlet hose 156 (FIG. 1) on the same side as the cooling unit 810. The ability to place each of these plumbing components 150 adjacent to or near one another on one side of the tub basin 110, facilitates the use of step 2308 and/or seat 2310 on that side to cover the cooling unit 810. As shown in FIG. 23A, the curvature 2312 when the step and/or seat 2310 are located on another side opposite or different from the cooling unit 810, the footprint of the tub 100 is reduced due to the compactness of the cooling unit 810 with curvature 2312.

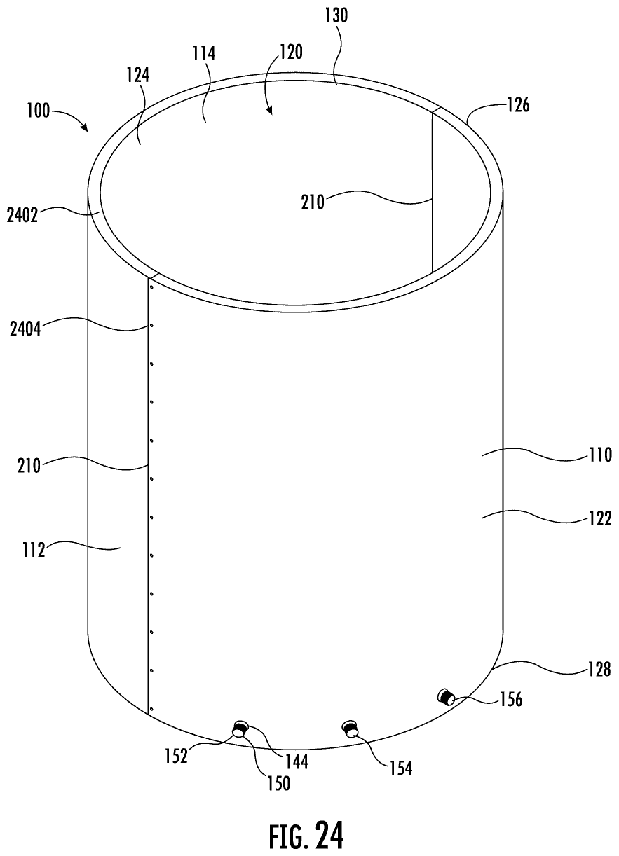

FIG. 24 shows the cold plunge tub 100 using ceramic insulation 2402. The use of ceramic insulation 2402 facilitates the formation of the structural substantially vertical seam 210 by using various fasteners 2404 at the vertical seam 210. In some aspects, the vertical seam 210 can form an air and/or watertight seal and can include a vacuum, as described above. Ceramic insulation 2402 can be located within and/or interposed between the outer tub sidewall 124 and the inner tub sidewall 126. Ceramic insulation 2402 can comprise the sidewalls 124, 126 and or be encapsulated within the walls as shown in FIG. 24.

Various plumbing components 150 can extend through the outer tub sidewall 122 and provide access to the drain hose 152, the inlet hose 154, and the outlet hose 156. The location of these plumbing components 150 can be modified to facilitate the placement of ergonomic device 2302 and/or other design specifications. For example, the position of hoses 152, 154, and 156 can be reversed, modified, and/or changed without affecting the scope of this disclosure.

In various aspects, the sidewalls 122 and/or 124 can be constructed from a metallic material or alloy. For example, sidewalls 122 and/or 124 can be constructed from aluminum, titanium, steel, and/or stainless-steel metal or alloy. sidewalls 122 and/or 124 can surround, capture, or enclose the ceramic insulation 2402. Ceramic insulation 2402 can comprise a ceramic fiber blanket interposed between the outer tub sidewall 124 and the inner tub sidewall 126. In some aspects, ceramic insulation 2402 can comprise other materials and can comprise, for example, a foam and/or fiber blanket inserted between sidewalls 122 and/or 124, and a vacuum depressurization can create a vacuum around the foam/blanket within the annular gap 310 (FIG. 3). In some aspects, fasteners 2404 can extend along the upper tub end 126 and/or the lower tub end 128.

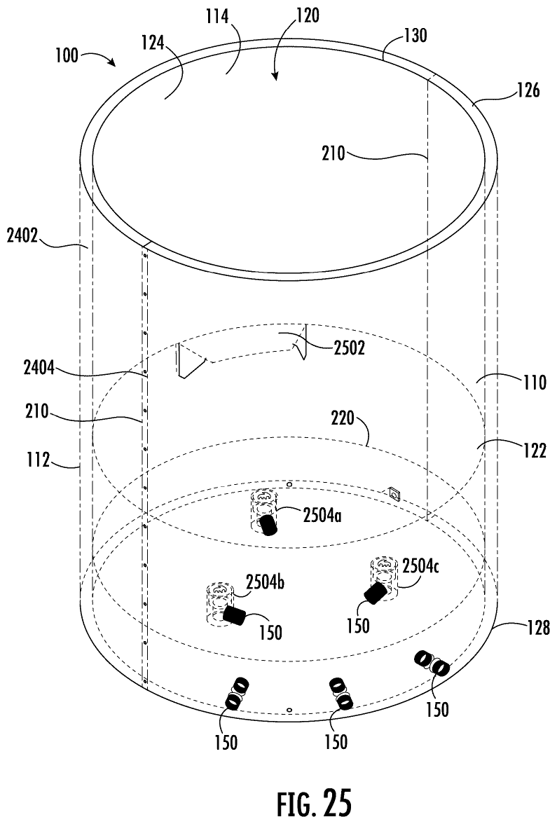

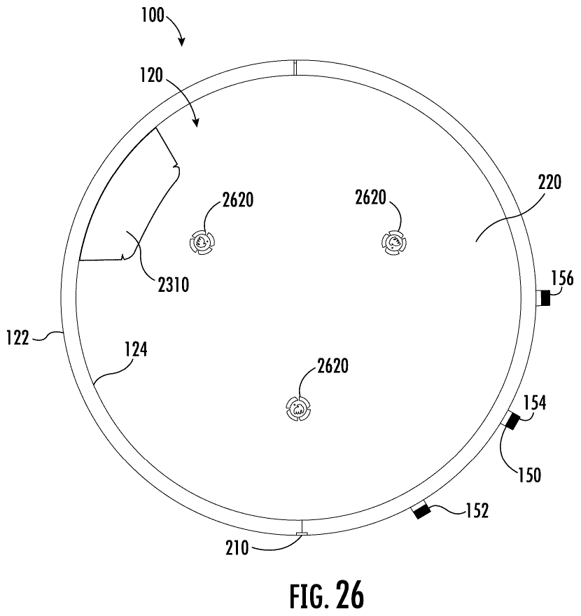

FIG. 25 is a perspective view of the cold plunge tub 100, with several portions shown in transparent to show a step 2502 connected on the outer tub sidewall 122 and/or the inner tub sidewall 124. FIG. 25 also shows the connection of three adapters 2504, shown as a drain adapter 2504a, an inlet adapter 2504b, and an outlet adapter 2504c. As shown in FIGS. 25 and 26, each adapter 2504 is coupled to a drain 2620 (FIG. 26) on the tub bottom wall 220.

FIGS. 25 and 26 show the plate of the tub bottom wall 220 coupled directly to adapters 2504. This configuration can eliminate the tub base 140. For example, tub base 140 can be formed within the inner and outer tub sidewalls 124,122 and the tub bottom wall 220 can be supported by brackets and/or adapters on the inner tub sidewall 124. In this way, the direct connection of drains 2620 in tub bottom wall 220 to adapters 2504 that support the tub bottom wall 220.

FIG. 26 is a top view of the cold plunge tub 100 showing an ergonomic device 2302, shown as seat 2310. Multiple drains 2620 are created in the tub bottom wall 220. As shown in FIG. 26, drain 2620 is formed by cutting or punching a hole in the plate forming the tub bottom wall 220 and may include logo 622 (FIG. 6) formations for the drain 2620. The vertical seam 210 extends across the annular gap 310 between the outer tub sidewall 122 and the inner tub sidewall 124. As shown in FIG. 26, the plumbing components 150 extend through outer tub sidewall 122 at or near the same side. In this way, the locations and/or placement of the drain hose 152, inlet hose 154, and outlet hose 156 facilitates locating the cooling unit 801 on one side of the cold plunge tub 100. For example, the seat 2310 can be located opposite the cooling unit 810 located under step 2308 (FIG. 23A).

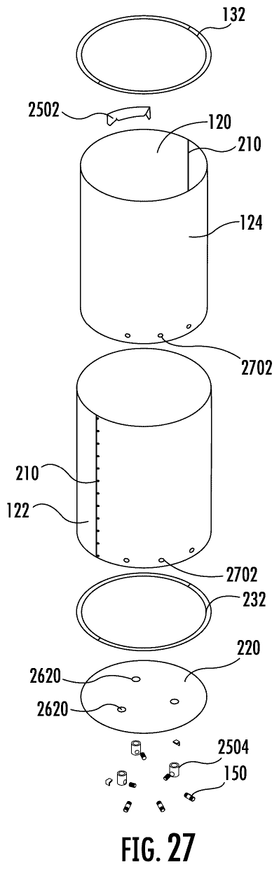

FIG. 27 is an exploded view of the cold plunge tub 100 and shows outlets 2702 in the inner and outer tub sidewalls 124,122. As described above, the elimination of the tub base 140 can be accomplished by the use of adapters 2504 supporting the tub bottom wall 220 and outlets 2702 extending through the inner and outer tub sidewalls 124,122. This aspect reduces parts and creates a more efficient tub. In addition, various ergonomic devices 2302 can be coupled to the outer tub sidewall 124. For example, step 2502 can facilitate movement/rotation of the tub, ingress and egress, and/or couple to another ergonomic device 2302, such as step 2308.

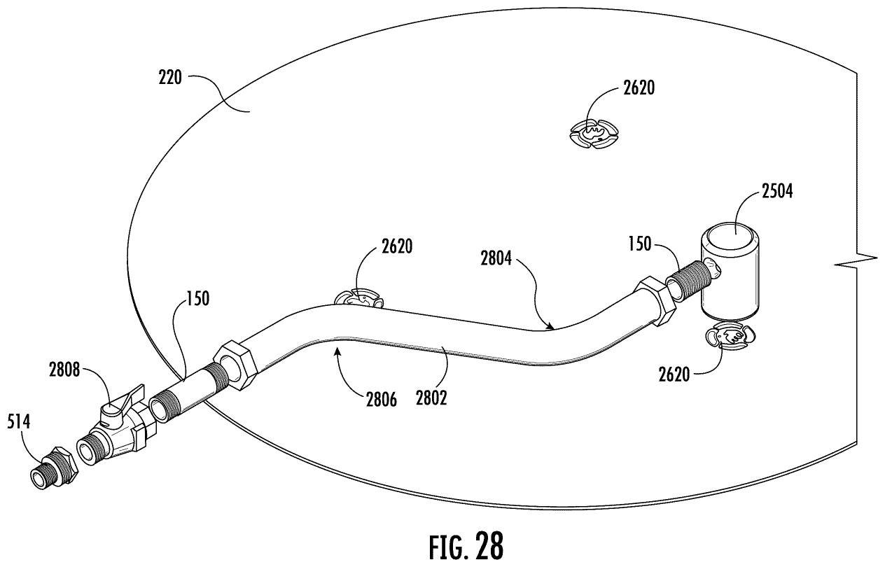

FIG. 28 shows one drain 2620 coupled to the adapter 2504. The adapter 2504 is interposed between the drain 2620 of the tub bottom wall 220 and a curved or non-linear hose or pipe 2802 fluidly communicating fluid to at least one of the drain hose 152, inlet hose 154, and the outlet hose 156 to clean and cool the water by passing it through one or more filters 2304, pump 2306, and cooling unit 810.

In various aspects, pipe 2802 comprises a first bend 2804 and/or a second bend 2806. For example, the first bend 2804 can be a substantially 45-degree angle, and the second bend 2806 can be a substantially 45-degree angle oriented opposite the first bend 2804 such that the outlet is linearly aligned with the inlet of the non-linear pipe 2802. Various valves 2808 can be coupled to pipe 2802 (e.g., hose 152, 154, and/or 156) and interposed between the adapter 2504 and the hose adapter 514 to control the flow to the cooling unit 810 and/or drained from the system.

Any feature described herein, such as, for example, and without limitation, the ergonomic device 2302 including the step 2502, step 2308, seat 2310, and/or pipes/hoses as well as other components of the cold plunge tub 100 and their arrangements, can comprise both functional and aesthetic elements, and any feature described as having functional aspects can have or define any one of several aesthetic designs without altering the respective parts' functions. If aesthetic elements are shown in the drawings or possibly fall within the scope of broader claim elements without being directly claimed, such disclosure or claims should not be interpreted as assigning any function to such aesthetic elements, which may, therefore, be separately protectable.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment. It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A tub comprising:
an insulated tub basin sized to receive a portion of a person and comprising:
an inner tub sidewall defining a reservoir for receiving fluid therein and sized to receive the portion of the person;
an outer tub sidewall surrounding the inner tub sidewall; and
a seal formed between the outer tub sidewall and the inner tub sidewall; and
a tub lid removably covering an upper reservoir opening of the reservoir.

2. The tub of claim 1, further comprising a reinforcement ring disposed within an annular gap between the outer tub sidewall and the inner tub sidewall.

3. The tub of claim 1, further comprising a central tub support extending downward from a central portion of a tub bottom wall and providing support to the insulated tub basin along a central basin axis.

4. The tub of claim 1, further comprising a vacuum between the inner tub sidewall and the outer tub sidewall, wherein the vacuum is sealed by the seal and thermally isolates a temperature of the inner tub sidewall from a temperature of the outer tub sidewall.

5. The tub of claim 1, further comprising a ceramic insulation material sealed and positioned between the inner tub sidewall and the outer tub sidewall, wherein the ceramic insulation material is positioned to thermally isolate a temperature of the inner tub sidewall from a temperature of the outer tub sidewall.

6. The tub of claim 1, wherein at least one of the inner tub sidewall, the outer tub sidewall, and the tub lid comprises aluminum.

7. The tub of claim 1, further comprising a chiller configured to regulate temperature of a fluid within the tub basin.

8. The tub of claim 1, further comprising a curved drain pipe comprising at least one bend.

9. The tub of claim 8, wherein the curved drain pipe is non-linear and comprises a first bend and a second bend such that an inlet is linearly oriented relative to an outlet and the curved drain pipe is non-linear.

10. A tub comprising:
an insulated tub basin sized to receive a portion of a person and comprising:
an inner tub sidewall defining a reservoir for receiving fluid therein and sized to receive a portion of the person;
an outer tub sidewall surrounding the inner tub sidewall; and
ceramic insulation material between the outer tub sidewall and the inner tub sidewall; and
a tub lid removably covering an upper reservoir opening of the reservoir.

11. The tub of claim 10, further comprising a drain filter engaged with a tub opening, the drain filter comprising a plurality of filter holes configured to allow fluid to flow through from the reservoir into the tub opening and the drain filter.

12. The tub of claim 10, further comprising a dual filter in a cooling unit between an inlet hose and an outlet hose, the dual filter configured to filter fluid from the inlet hose to the outlet hose in two separate stages.

13. The tub of claim 10, further comprising a pump, a cooler, and a heater, wherein the cooler and the heater maintain a temperature of fluid pumped through the pump to maintain a user-set temperature in the reservoir.

14. The tub of claim 10, wherein a lower wall portion of the inner tub sidewall extends downward beyond a tub bottom end of the insulated tub basin to define a base wall of the insulated tub basin.

15. The tub of claim 10, wherein the ceramic insulation material is positioned to thermally isolate a temperature of the inner tub sidewall from a temperature of the outer tub sidewall.

16. The tub of claim 10, wherein at least one of the inner tub sidewall, the outer tub sidewall, and the tub lid comprises aluminum.

17. The tub of claim 10, further comprising a chiller configured to regulate temperature of a fluid within the tub basin.

18. The tub of claim 10, further comprising a pipe comprising at least one bend, wherein the pipe is non-linear and comprises a first bend and a second bend such that an inlet is linearly oriented relative to an outlet and the pipe is non-linear.

19. The tub of claim 10, wherein the tub lid comprises an annular lid groove formed in an inner lid surface, wherein the tub lid removably covers the upper reservoir opening and the annular lid groove is configured to receive the upper reservoir opening of the insulated tub basin to prevent lateral movement of the tub lid relative to the insulated tub basin.

20. The tub of claim 19, wherein the tub lid further comprises a lid vent formed through the tub lid and configured to allow air and/or steam to escape from the reservoir through the tub lid.
